(19) United States
(12) Patent Application Publication
(10) Pub. No.: US 2007/0098221 A1
(43) Pub. Date: May 3, 2007

(54) Method for detection and tracking of deformable objects using adaptive time-varying autoregressive model

(76) Inventors: Charles Florin, Princeton, NJ (US); Nikolaos Paragios, Vincennes (FR); James P. Williams, Princeton Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/511,527

(22) Filed: Aug. 28, 2006

Related U.S. Application Data
(60) Provisional application No. 60/730,896, filed on Oct. 27, 2005.

(51) Int. Cl. G06K 9/00; G06K 9/34; G06K 9/62

(52) U.S. Cl. 382/103; 382/173; 382/159

(57) ABSTRACT

A method is provided for segmenting a moving object immersed in a background, comprising: obtaining a time-varying autoregressive model of prior motion of the object to predict future motion of the object; predicting a subsequent contour of the object from the background using the obtaining time-varying autoregressive model comprising using the obtained time-varying autoregressive model to initialize and/or constrain segmentation of the object from the background, and segmenting the object using the predicted subsequent contour and updating the autoregressive model while tracking of the segmented object.

### CROSS REFERENCE TO RELATED APPLICATION

This application claims priority from U.S. Provisional application No. 60/730,896 filed Oct. 27, 2005, which is incorporated herein by reference.

### TECHNICAL FIELD

This invention relates generally to object detection and more particularly to the detection and tracking of deformable objects.

### BACKGROUND OF THE INVENTION

As is known in the art, tracking highly deforming structures in space and time arises in numerous applications in computer vision. Static Models are often referred to as linear combinations of a mean model and modes of variations learned from training examples. In Dynamic Modeling, the shape is represented as a function of shapes at previous time steps.

For example, it is frequently desirable to detect and segment an object from a background of other objects and/or from a background of noise, collectively referred to herein as background. One application, for example, is in MRI where it is desired to segment an anatomical feature of a human patient, such as, for example, a vertebra of the patent where the background is surrounding organs and/or tissue. In other cases it would be desirable to segment a moving, deformable anatomical feature such as the heart.

Motion perception is a fundamental task of biological vision, with motion estimation and tracking being the most popular and well-addressed applications. To this end, given a sequence of images, one would like to recover the 2D temporal position of objects of particular interest. These applications often serve as input to high-level vision tasks, like 3D reconstruction, etc.

Tracking non-rigid objects is a task that has gained particular attention in computational vision. Starting from the pioneering formulation of the snake model described by Kass, A. Witkin, and D. Terzopoulos in a paper entitled “Snakes: Active Contour Models” published in IEEE International Conference in Computer Vision, pages 261-268, 1987 several attempts to address tracking through the deformation of contours can be found in the literature either model-free (see M. Isard and A. Blake. Contour Tracking by Stochastic Propagation of Conditional Density) or model-based T. Cootes, C. Taylor, D. Cooper, and J. Graham. Active shape models—their training and application. (see Computer Vision and Image Understanding, 61:38-59, 1995). Level set methods (see S. Osher and J. Sethian. Fronts propagating with curvature-dependent speed: Algorithms based on the Hamilton-Jacobi formulation. Journal of Computational Physics, 79: 12-49, 1988) is an alternative technique (see S. Osher and N. Paragios. Geometric Level Set Methods in Imaging, Vision and Graphics. Springer Verlag, 2003) to track moving interfaces through model-free (see N. Paragios and R. Deriche. Geodesic Active Contours and Level Sets for the Detection and Tracking of Moving Objects. IEEE Transactions on Pattern Analysis and Machine Intelligence, 22:266-280, 2000) or model-based (see D. Cremers. A Variational Framework for Image Segmentation Combining Motion Estimation and Shape Regularization. In IEEE Conference on Computer Vision and Pattern Recognition, pages 53-58, 2003) methods with the advantage of being implicit, intrinsic and parameter-free. Such methods are able to capture important non-linear deformations.

Introducing prior knowledge within visual perception has been an on-going effort to a number of vision tasks, like segmentation, motion analysis, 3D reconstruction, etc. Tracking was a domain that has benefited from such an effort, in particular when dealing with objects and structures of limited variation in space and time. To this end, different approaches were considered either based on snakes (see D. Cremers, F. Tischhauser, J. Weickert, and C. Schnorr. Diffusion snakes: Introducing statistical shape knowledge into the mumford-shah functional. International Journal Computer Vision, 50(3):295-313, 2002), active shape and appearance models (see T. F. Cootes, G. J. Edwards, and C. J. Taylor. Active appearance models. Lecture Notes in Computer Science, 1407:484 1998 and T. F. Cootes, C. J. Taylor, D. H. Cooper, and J. Graham. Active shape models—their training and application. Comput. Vis. Image Underst., 61(1):38-59, 1995) level sets (see T. Zhang and D. Freedman. Tracking objects using density matching and shape priors. In ICCV, pages 1056-1062, 2003), etc. Such approaches model spatial variation of the structure of interest in a probabilistic fashion. Then, during the inference process a constraint on recovering shapes that belong to the learned family is imposed.

Temporal models like Kalman snakes (see D. Terzopoulos and R. Szeliski. Tracking with Kalman Snakes. In A. Blake and A. Yuille, editors, Active Vision, pages 3-20. MIT), multiple hypotheses trackers (see M. Isard and A. Blake. Contour Tracking by Stochastic Propagation of Conditional Density. In European Conference on Computer Vision, volume I, pages 343-356, 1996 and K. Toyama and A. Blake. Probabilistic Tracking in a Metric Space. In IEEE International Conference in Computer Vision, pages 50-59, 2001) address tracking in a difference dimension. Constraints/models are imposed in the temporal evolution of the target and prediction mechanisms are used to perform tracking. Shape tracking with autoregressive dynamic models is a step forward in this direction, with different shape spaces being investigated. In a paper by J. C. Nascimento, J. S. Marques, and J. M. Sanches. Estimation of cardiac phases in echo-graphic images using multiple models. In ICIP (2), pages 149-152, 2003, a first-order model is used to track cardiac cycles echocardiographic sequences while in [C.-B. Liu and N. Ahuja, A model for dynamic shape and its applications. In CVPR (2), pages 129-134, 2004 Fourier descriptors are used to describe shapes, and a LDM tracks their evolution on time. Tracking articulated structures is problem well suited for autoregressive models and therefore in a paper by A. Agarwal and B. Triggs. Tracking articulated motion using a mixture of autoregressive models. In European Conference on Computer Vision, pages III 54-65, Prague, May 2004 a method based on a linear dynamic model was proposed. The main limitation of such models refer to their time-invariant nature. Temporal models as well as shape representations have been learned from previous sequences, used within tracking and not updated. Consequently, either a complex heuristic is developed to mix models, or Markov fields are introduced for multimodality.

### SUMMARY

In accordance with the present invention, a method is provided for segmenting a moving object immersed in a background, comprising: obtaining a time-varying autoregressive model of prior motion of the object to predict future motion of the object; predicting a subsequent contour of the object from the background using the obtaining time-varying autoregressive model comprising using the obtained time-varying autoregressive model to initialize and/or constrain segmentation of the object from the background, and segmenting the object using the predicted subsequent contour and updating the autoregressive model while tracking of the segmented object.

The method includes modeling the object shape from prior information and updating the object shape during the object tracking.

The method uses the spatial and the temporal information on the object deformation. Because of its time-varying nature, the method reformulates tracking as a high order time series prediction mechanism that goes beyond Kalman and Particle filters. Samples (toward dimensionality reduction) are represented in an orthogonal basis and are introduced in an autoregressive (AR) model that is determined through an optimization process in appropriate metric spaces. Toward capturing evolving deformations as well as cases that have not been part of the learning stage, a process that updates on-line both the orthogonal basis decomposition as well as the parameters of the autoregressive model is described. Promising experimental results in tracking explicit shapes in a video sequence that could be used to impose prior knowledge in segmentation are presented.

The method uses an on-line technique for tracking based on higher order autoregressive models. Such a technique is based on dimensionality reduction of the parameter space using an orthogonal decomposition of the training set. Then, a linear autoregressive model is built in such space capable of predicting current states from the prior ones. Such model as well as its feature space (the orthogonal decomposition of shapes) are updated on-line using new evidence. To this end, a proper geometric distance is used in a robust framework to determine the parameters of the model.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a shows in the left section thereof a training example having therein an object to be tracked by the process of FIG. 8 used for segmenting and tracking the object immersed in a background of noise according to the invention, shows in the center section thereof a contour map of the object and shows in the right section thereof a mean contour of the object;

FIG. 2 shows registered training examples used for Principal Component Analysis used in the process of FIG. 8;

FIG. 3 are true contours (dashed) and contours predicated from previous states, and adaptive time varying (TVAR) model (solid);

FIG. 4 shows true contours and predicated projection contours projected on the image of the object;

FIG. 5 is a graph showing the sum of square errors in observation space between predication and real states with respect to the noise standard deviation;

FIG. 6 is a graph showing the sum of square errors in observation space between predication and real states with respect to the number of time steps after the model is changed

FIG. 7 shows the object after the contour is predicted in accordance with the process of FIG. 8 with an image term used to correct the predication; and

FIG. 8 a flow diagram of a process used for segmenting and tracking a moving object immersed in a background of noise according to the invention, portions being shown in more detail in FIGS. 8A and 8B.

Like reference symbols in the various drawings indicate like elements.

### DETAILED DESCRIPTION

### General

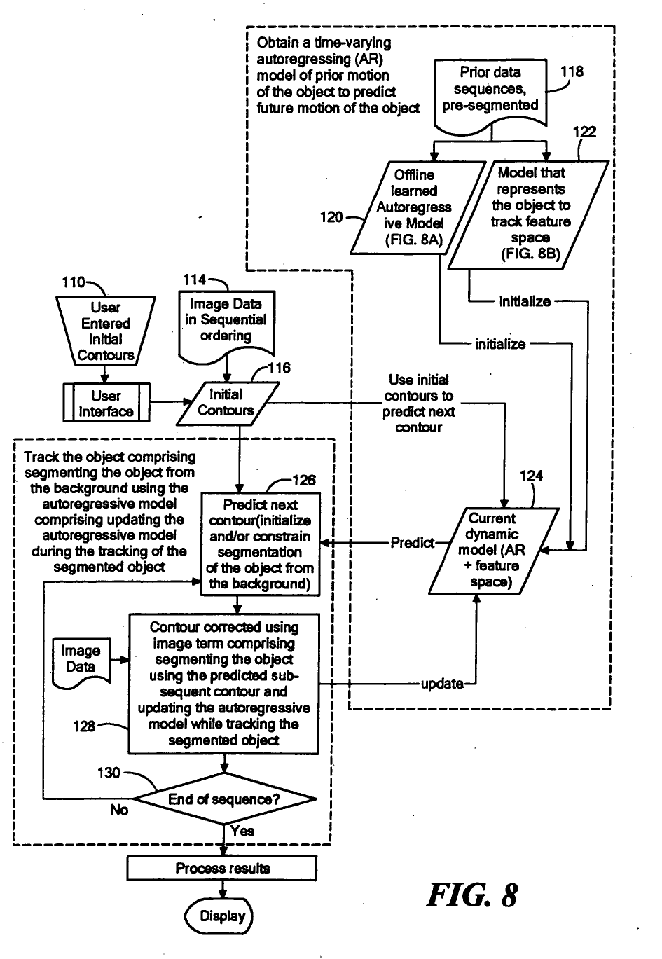

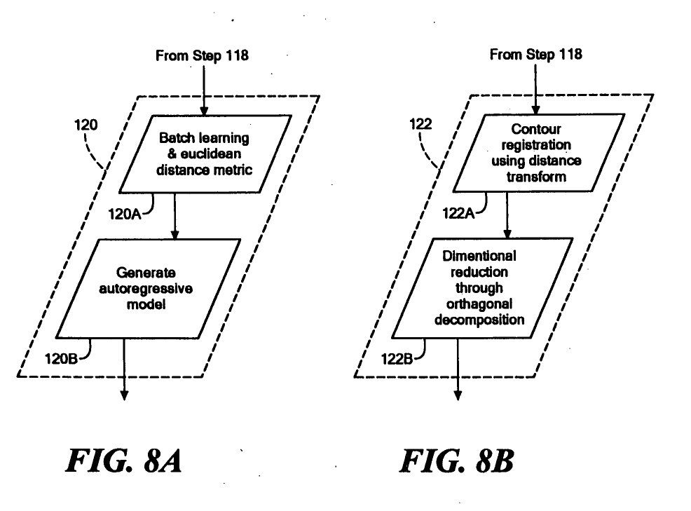

Referring now to FIG. 8 a flow diagram is shown for segmenting and tracking a moving object immersed in a background, here a background of noise, comprising: obtaining a time-varying autoregressive model of prior motion of the object to predict future motion of the object (described in more detail in Step 122A); and, tracking the object comprising segmenting the object from the background using the autoregressive model; and updating the autoregressive model during the tracking of the segmented object (described in more detail in Step 122B and Step 120A) below). More particularly, the method includes obtaining a time-varying autoregressive model of prior motion of the object to predict future motion of the object (Steps 120 and 122); predicting a subsequent contour of the object from the background using the obtaining time-varying autoregressive model comprising using the obtained time-varying autoregressive model to initialize and/or constrain segmentation of the object from the background (Step 126); and segmenting the object using the predicting a subsequent contour and updating the autoregressive model while tracking of the segmented object (Step 128).

A time-varying autoregressive model of prior motion of the object to predict future motion of the object comprises having a user enter initial contour data of the object, Step 110, through a user interface. This may be by the user tracing the contour of the object using a tracing pen on a display of an MRI system, for example, Step 110. Also, a database 114 provides sequentially ordered image data of the object in the absence of background to thereby provide a sequence of contours of the object (Step 116) thereby enabling predication of the next object in the sequence. Here, the object will be a person such object being deformed as the person walks. In an MRI application the object may be the human heart which becomes deformed by the beating action of the heart. Thus, in Step 114 an initial set of time sequenced images, here k images, comprising the object in background is provided. These images are segmented using user interaction (Step 110) to provide the initial contours (Step 116).

Also, pre-segmented previously obtained sequences (Step 118) are used to provide an offline learned autoregressive model (Step 120) and a model that represents the object to track in feature space (Step 122). More particularly, the first k contours may not suffice to estimate the model. Therefore, previous knowledge of the object to track (step 118) is necessary to have a rough estimation of the dynamic model (step 120) and the feature space represented in an orthogonal basis such as, for example, Principle Component Analysis (PCA), Step 120). It should be understood that other method than PCA may be used, see for example, Kernel PCA: “Nonlinear component analysis as a kernel eigenvalue problem”, by Bernhard Schölkopf, Alexander Smola and Klaus-Robert Müller, Neural Computation, 10:1299-1319, 1998 and Fourier Coefficients: “Fourier-based invariant shape prior for snakes” by Derrode, S. and Chermi, M. A. and Ghorbel, F., ICASSP 2006

The predicated next contour provided in Step 116 is used for the current (i.e., on line updated autoregressive model) dynamic autoregressive (AR) model (Step 124), described in more detail in Step 120B, such model being initialized by the offline learned autoregressive model (Step 120) and the model that represents the object to track feature space (Step 122).

The process of tracking the object comprising segmenting the object from the background using the autoregressive model; and updating the autoregressive model during the tracking of the segmented object includes using the predicated next contour provided in Step 116. The predicated next contour provided in Step 116 is used with the initial contour provided in Step 116 is used to predict the next contour of the object, Step 126. The next predicted contour (Step 126) along with image data of the object immersed in the background noise is used to determine a contour corrective term, Step-128 (see equation (6) below. The contour corrective term, Step 128, is used to update the current (i.e., on line updated autoregressive model) dynamic autoregressive (AR) model (Step 124) during the sequence (i.e., until the end of the sequence on motion), Step 130.

### Tracking & On-Line Update (Step 122)

Tracking and online updating (Step 122) is a two-step process (FIG. 8B): tracking Step 122A followed by updating Step 122B.

Considering first Step 122A, it is noted that general autoregressive system can be used to perform tracking. Without loss of generality we assume that objects are represented using a number of control points. In that case, tracking consists of a contour registration step, a dimensionality reduction step, a batch learning step and an on-line-adaptation step of the model as well as the target representation. Here, contour registration using distance transforms is used for tracking. Implicit methods are popular shape representations. Let us consider a number of training examples to tracking, s={sᵢ,iε[1,m]} (see X. Huang, N. Paragios, and D. Metaxas. Establishing local correspondences toward compact representations of anatomical structures. In Medical Image Computing & ComputerAssisted Intervention, pages 926-934, 2003, and N. Paragios, M. Rousson, and V. Ramesh. Matching Distance Functions: A Shape-to-Area Variational Approach for Global-to-Local Registration. In European Conference on Computer Vision, pages II:775-790, 2002) a distance transform representation ψᵢ was considered for a given shape sᵢ;

$${ψ}_{i} ( x ) = \{ \begin{matrix}0 , x ∈ {s}_{i} + \\ D ( x , {s}_{i} ) > 0 , x ∈ {Ω}_{i} - \\ D ( x , {s}_{i} ) < 0 , x ∈ [ Ω - {Ω}_{i} ]\end{matrix} \qquad ( 2 )$$

with Ω be the image domain. Global registration between shapes can now be addressed within an optimization framework that involves their distance function. Affine models transformations are often used to capture image motions and therefore, one can decompose the registration process in a global and a local element. The global one can be determined using the affine component and the local one using free form deformations (see X. Huang, N. Paragios, and D. Metaxas. Establishing local correspondences toward compact representations of anatomical structures. In Medical Image Computing & ComputerAssisted Intervention, pages 926-934, 2003). In the absence of important scale variations between the examples of the training set, the sum of squared differences (see N. Paragios, M. Rousson, and V. Ramesh. Matching Distance Functions: A Shape-to-Area Variational Approach for Global-to-Local Registration. In European Conference on Computer Vision, pages II:775-790, 2002) can be used to determine the affine transformation between two shapes;

$$E ( {A}_{i} ) = \int {\int }_{Ω} ρ ( {ψ}_{i} ( x ) - ψ ( {A}_{i} ( x ) ) ) ⅆ x$$

through a gradient descent optimization method. The case of scale variations can be addressed through the use of mutual information (see) N X. Huang, N. Paragios, and D. Metaxas. Establishing local correspondences toward compact representations of anatomical structures. In Medical Image Computing & ComputerAssisted Intervention, pages 926-934, 2003. Local registration toward one to one correspondences between contour points can be efficiently achieved using a free form deformation in the space of distance transforms.

An elegant way to overcome, to some extend, such limitation refers to the use of warping techniques and free form deformations, that are quite popular in graphics, animation and rendering (see P. Faloutsos, M. van de Panne, and D. Terzopoulos. Dynamic Free-Form Deformations for Animation Synthesis. IEEE Transactions on Visualization and Computer Graphics, 3:20 1-214, 1997. The essence of traditional FFD is to deform an object by manipulating a regular control lattice P overlaid on the volumetric embedding space.

Let us consider a regular lattice of control points [P_{m,n}; m=1,M,n=1,N] overlaid to a region [φᵢx] in the embedding space that encloses the source structure. Let us denote the initial configuration of the control lattice as P⁰, and the deforming control lattice as P=P⁰+δP. Under these assumptions, the incremental FFD parameters are the deformations of the control points in both directions x.

The motion of a pixel x given the deformation of the control lattice from P⁰ to P, is defined in terms of a tensor product of Cubic B-spline. The parameters of such deformation Lᵢ can also be recovered through the use of an SSD with additional regularization constraints;

$$E ( {L}_{i} ) = \int {\int }_{Ω} ρ ( {ψ}_{i} ( x ) - ψ ( {L}_{i} ( x ) ) ) ⅆ x + \int {\int }_{Ω} ( {\vert {L}_{i , x x} \vert}^{2} + {\vert {L}_{i , y y} \vert}^{2} + 2 {\vert {L}_{i , x y} \vert}^{2} ) ⅆ x$$

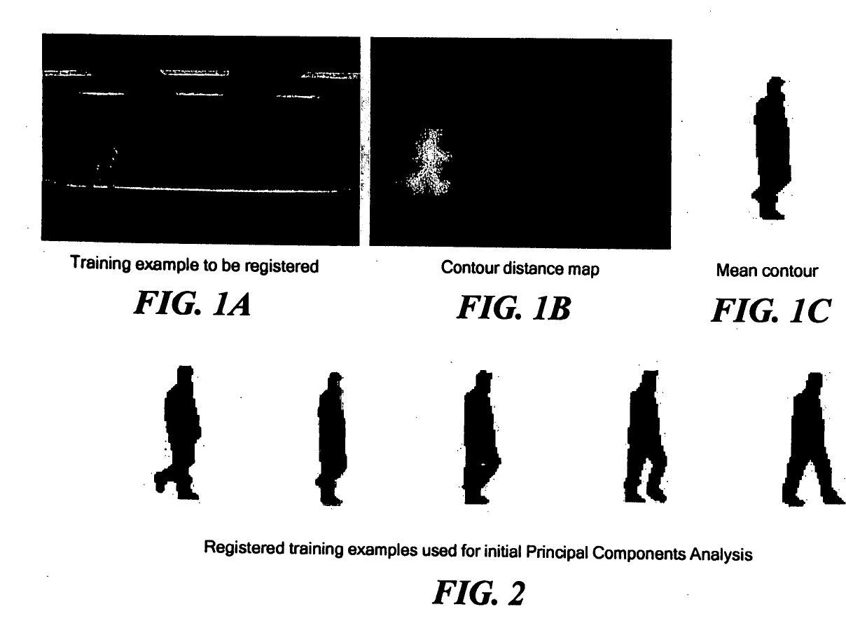

as proposed in X. Huang, N. Paragios, and D. Metaxas. Establishing local correspondences toward compact representations of anatomical structures. In Medical Image Computing & ComputerAssisted Intervention, pages 926-934, 2003. Experimental results of such registration process are shown in FIG. 1. The registration of shapes in the implicit space allows the recovery of correspondences between the training examples at various scales. Therefore, based on the number of examples we select a number of control points (100) and consider a uniform sampling rule where a valid statistical analysis of the distribution of points can be attained. However, building high order prediction mechanisms in such dimensional spaces is rather impossible and therefore a dimensionality reduction step is to be considered.

Then in Step 122B, let s̅_{i=1 . . . n} be a column vector representation of the previous n registered examples according to a sampling rule. Principle Component Analysis (PCA) can be applied to capture the statistics of the corresponding elements across the training examples shown in FIG. 2. PCA refers to a linear transformation of variables that retains—for a given number m of operators—the largest amount of variation within the training data, according to:

$$s = \overline{s} + {\sum }_{q = 1}^{m} {b}_{q} ( {u}_{q} , {v}_{q} ) = \overline{s} + {\sum }_{q = 1}^{m} {b}_{q} {U}_{q} \qquad ( 3 )$$

where s̅ is the mean shape, m is the number of retained modes of variation, U_{q} are these modes (eigenvectors), and b_{q} are linear factors within the allowable range defined by the eigenvalues.

Without loss of generality, a zero mean assumption can be considered for the { s̅ᵢ} by estimating the mean vector s̅ and subtracting it from the training samples { s̅ᵢ}. Given the set of training examples and the mean vector, one can define the covariance matrix as follows:
Σ̅=E{ s̅ᵢ s̅ᵢ^{T}}
It is well known that the principal orthogonal directions of maximum variation for { s̅ᵢ} are the eigenvectors of Σ̅. One can replace the Σ̅ with the sample covariance matrix that is given by [ s̅_{M}^{T} s̅_{M}], where s̅_{M} is the matrix formed by concatenating the set of examples s̅_{i=1 . . . n}.

Then, the eigenvectors of Σ̅ can be computed through the singular value decomposition (SVD) of s̅_{M}=UΣV^{T}. The eigenvectors of the covariance matrix Σ̅ are the columns of metric U while the elements of the diagonal matrix Σ refer to the variance of the data in the direction of the basis vectors. Such information can be used to determine the number of basis vectors (m) required to retain certain percentage of the variance in the data.

Referring now in more detail to Step 120, the autoregressive models is developed. The process (i.e., Step 120) is a two-step process (FIG. 8A): First performing contour registration using a distance transformation, Step 120A; followed by a dimensional reduction through orthogonal decomposition (Step 120B).

In Step 120A, it is first noted that time series models are very popular in a number of domains like signal processing. Let us assume a set of temporal observations X={Xᵢ; i=0,k} generated from a multivariate distribution p( ). Linear autoregressive models—of order k—consist of expressing the current observation, as a combination of previous samples perturbed by some noise model;
Xₜ=H[Xₜ₋₁Xₜ₋₂ . . . Xₜ₋ₖ]+η(μ,Σ)
with H being prediction matrix and η(μ,Σ) being the noise model. In the most general case one can assume that the input variable X is defined in high-dimensional spaces and therefore some dimensionality reduction is to be performed. Without loss of generality, we can assume a set of either linear or non-linear operators φᵢ( ); iε[1,m] that when applied to the input variable X they form a new basis of observations
Y=(φ₁(X),φ₂(X), . . . , φₘ(X)) (1)
or a new random variable. We can further assume that such operators could be inverted, or from a feature vector Y one can recover the original observation X. In that case one can restate the autoregressive model in a lower dimensional space;
Yₜ=H_{φ}[Yₜ₋₁Yₜ₋₂ . . . Yₜ₋ₖ]+η_{φ}(μ,Σ)
Estimation of such a model can be done from a set of training examples and robust regression. Let us assume that n>>k observations are available. Once such observations have gone through dimensionality reduction, we obtain an over-constrained linear system;
Yₙ←Yₙ=H_{φ}[Yₙ₋₁Yₙ₋₂ . . . Yₙ₋ₖ]
Yₖ←Yₖ=H_{φ}[Yₖ₋₁Yₖ₋₂ . . . Y₀]
The unknown parameters of such over-constrained system can be determined through a robust least square minimization

$${H}_{ϕ} = arg {min}_{H} \{ {\sum }_{i = k}^{n} {ρ}_{η} ( {Y}_{i} , {Y}_{i} ) \}$$

with p( ) being a robust distance metric between actual observations and predictions that depends on the noise model. The Euler-Lagrange equations of such a system lead a linear problem to be solved that is done in a straightforward fashion. The number of constraints used in such a procedure can be done using the Schwartz's Bayesian criterion. Such a batch estimation of the parameters of the autoregressive model can be performed off-line, Step 120

Considering now Step 120B, tracking, it is first noted that the use the principal component analysis (PCA) decreases the problem dimensionality leading to a highly non uniform feature space (for the range of translation component is far superior to the one of the scale). Therefore, within the prediction mechanism, defining error metrics in such space could lead to erroneous results and approximations since more importance will be given to parameters with important range like translation. On the other hand, the impact of local variations will be greatly diminished. In order to overcome such a limitation, we propose the use of original space to recover the prediction mechanism on the reduced space.

Let us consider s̅ᵢ=( x̅ᵢ^{j}; jε[1,w]) with xᵢ^{j} be the coordinates of the j^{th} point of the registered version of the contour sᵢ. Similar to that, using the prediction mechanism, one can recover the actual parameters of the transformation
Yᵢ=H_{φ}[Yᵢ₋₁Yᵢ₋₂ . . . Yᵢ₋ₖ]
that should be applied to the mean contour s̅ᵢ toward the actual observation sᵢ (see [EQ. (3)]). Without loss of generality we can decompose the feature vector Yᵢ in the global and a local component Yᵢ=[Aᵢ Aᵢ]. Subsequently, to verify [EQ. (1)], the following condition is to be satisfied:
xᵢ^{j}=Aᵢ( x̅ᵢ^{j})+ΛᵢU

Such condition is to be satisfied for all control points, and therefore one can consider the euclidean distance between the prediction and the actual observations in the image coordinate system to be the error metric of the auto-regressive model;

$${ρ}_{η} ( {Y}_{n} , {Y}_{n} ) = {\sum }_{j = 1}^{w} {\vert {x}_{i}^{j} - ( {A}_{i} ( {\overline{x}}_{i}^{j} ) + {Λ}_{i} U ) \vert}^{2} \qquad ( 4 )$$

that refers to well behaved distance between observations and predictions and implicitly accounts for the ranger of parameters of the autoregressive model. The Euler-Lagrange equations lead to a linear system that can be solved through a matrix inversion and provides the initial state of the prediction mechanism.

Once new observations have been introduced to the process, the prediction matrix as well as the orthogonal basis are to be updated. Incremental principal component analysis can be used for the basis, while an exponential forgetting method is more suitable for the prediction matrix.

### On-Line Adaptation of the Model (Step 124)

Referring now in more detail to Step 124, such Step 124 includes adaptation of the Orthogonal Basis, Step 124A, followed by Adaptation of the Predictive Model, Step 124B.

Describing first Step 124A, here the process uses as the orthogonal basis, PCA, see Incremental PCA (see P. Hall and R. Martin. Incremental eigenanalysis for classification. In Proc. British Machine Vision Conference, volume 1, pages 286-295, 1998 and Y. Li. On incremental and robust subspace learning. Pattern Recognition, 37(7):1509-1518, 2004, the latest observation can be added to the PCA learning set and the decomposition updated. Thus, a new feature space is to be used to represent the state decomposition X. Using these new variation modes, and the corrected state \hat{X}ₜ, the transition model is then updated and ready to be used to predict the following state Xₜ₊₁. The method presented in P. Hall and R. Martin. Incremental eigenanalysis for classification. In Proc. British Machine Vision Conference, volume 1, pages 286-295, 1998 can be summarized as follows: given a PCA at time t−1, mean X̅ₜ₋₁, a set of eigenvectors Uₜ₋₁=[uᵢ], and their corresponding eigenvalues Γₜ₋₁=diag (da₁, λ₂, . . . ), given a new state Xₜ, the PCA is updated at time t starting by the mean:

$${\overline{X}}_{t} = \frac{( t - 1 ) {\overline{X}}_{t - 1} + {X}_{t}}{t} .$$

The eigenvector matrix is updated by adding the new vector's residual h and applying a rotation R on the former eigenbasis:

$${U}_{t} = [ {U}_{t - 1} \frac{h}{{‖ h ‖}_{2}} ] R . \qquad ( 5 )$$

For a covariance matrix Cₜ, CₜUₜ=Γt₋₁Uₜ. Noticing that the covariance matrix is updated as follows:

$${C}_{t} = \frac{t - 1}{t} {C}_{t - 1} + \frac{t - 1}{{t}^{2}} ( {X}_{t} - {\overline{X}}_{t} ) {( {X}_{t} - {\overline{X}}_{t} )}^{T} ,$$

then, one can conclude that (R,Γₜ), ([EQ. (5)]) is the solution of the eigen problem
DR=RΓₜ,
where

$$D = \frac{t - 1}{t} [ \begin{matrix}{Λ}_{t - 1} & 0 \\ 0 & 0\end{matrix} ] + \frac{t - 1}{{t}^{2}} [ \begin{matrix}g {g}^{T} & γ g \\ γ {g}^{T} & {γ}^{2}\end{matrix} ] ,$$

with γ=h^{T}(Xₜ− X̅ₜ) and g=U^{T}(Xₜ− X̅ₜ).

Next, in Step 124B, let us now assume that new observations are present. Once the prediction matrix has been estimated, new observations are introduced in the system toward decreasing the prediction error. To this end, one would like to find the lowest potential of

$${E}_{n + 1} ( {H}_{ϕ} ) = min \{ {\sum }_{i = k}^{n} {ρ}_{η} ( {Y}_{n} , {Y}_{n} ) + {ρ}_{η} ( {Y}_{n + 1} , {H}_{ϕ} [ {X}_{n} {X}_{n - 1} … {X}_{n - k + 1} ] ) \}$$

In order to simplify the notation, we can assume that ρ is the L−2 norm (see [EQ. (4)]), leading to an iterative least squares estimation problem with iterative Gauss-Newton method being the most popular technique to address such optimization (see D. P. Bertsekas. Incremental least squares methods and the extended kalman filter. SIAM J. on Optimization, 6(3):807-822, 1996), the result is obtained by dividing the sum of squares into blocks, solving the problem for the first block and using this result as initialization once the following block is added to the previous block. It should be understood that other methods exist to solve least squares iteratively. The least squares minimization (line 10, page 13) is part of Step 124. Unlike the method presented here, D. P. Bertsekas. Incremental least squares methods and the extended kalman filter. SIAM J. on Optimization, 6(3):807-822, 1996 solved the Gauss-Newton iterations using Extended Kalman Filter for nonlinear measures E(H,μ,Σ). Experiments have shown that few (a couple of dozen) Gauss-Newton iterations are required to achieve far better results than a simple time-invariant dynamic model.

For non-linear time processes, the local approximation of (Hₙ₊₁,μₙ₊₁,Σₙ₊₁) may not well correspond to the state transition in a very early time step. For that reason, exponential forgetting is introduced;

$${E}_{n + 1} ( {H}_{ϕ} ) = min \{ {\sum }_{i = k}^{n} {w}_{n - k - i} {ρ}_{η} ( {Y}_{n} , {Y}_{n} ) + {w}_{n + 1} {ρ}_{η} ( {Y}_{n + 1} , {H}_{ϕ} [ {X}_{n} {X}_{n - 1} … {X}_{n - k + 1} ] ) \} \qquad ( 6 )$$

with exponential weights wₜ=e^{-t/τ}, where τ is the exponential forgetting window size. The smaller τ the more reactive but also the more sensitive to noise is the TVAR, as it will be demonstrated in the Implementation and Results Sections below.

### Implementation & Results

### Implementation

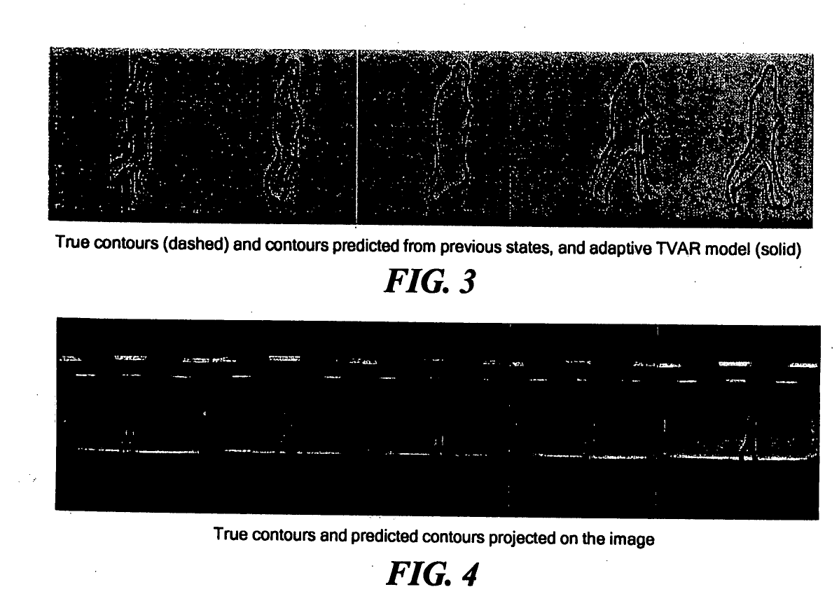

In order to validate such a method, hand-drawn contours were considered from several sequences with objects undergoing heavy variation. Furthermore, within the sequences different motion dynamics were present. The method was trained using a small number of training examples. The prediction method was used to determine future positions of the objects shown in FIG. 3 while new observations were fed to the system to update the orthogonal basis and the prediction matrix. Some qualitative results are shown in FIG. 4. In order to further validate the method, a quantitative analysis was also performed and comparisons with linear models like Kalman filter and time invariant autoregressive models.

### Comparison with Kalman Filter

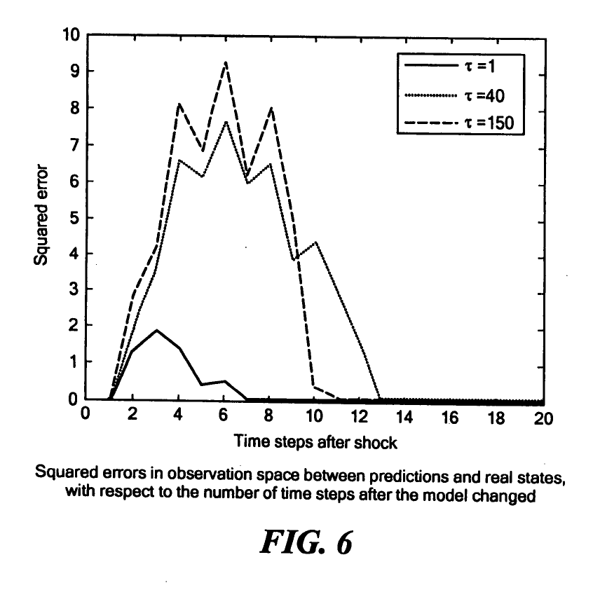

To measure the efficiency of a TVAR model in capturing non-linear processes, a comparison was made with a very common Bayesian prediction/correction scheme: the Kalman filter (see R. E. Kalman. A new approach to linear filtering and prediction problems. Transactions of the ASME—Journal of Basic Engineering, 82(Series D):35-45, 1960). Using a sequence with a non-linear process (a man walks, then runs), two experiments were made: one with a TVAR model as explained in connection with Step 122, and another one where the states prediction is filtered by a Kalman filter. When a TVAR model is used, and the results are filtered by a Kalman filter R. E. Kalman. A new approach to linear filtering and prediction problems. Transactions of the ASME—Journal of Basic Engineering, 82(Series D):35-45, 1960, the mean squared distance between the filtered and observed curves is about 10% higher than the same mean distance when it is not filtered. The Kalman filter needs a certain number of steps to recover from a non-linear transition (from walking to running), while the TVAR needs much fewer steps. The number of steps increases with the width r of the exponential forgetting window, see FIG. 6.

### Comparison with Previous Work

Our approach has three important advantages compared to the prior ones; (i) instead of estimating the dynamic model in the feature space (the parameterization Y chosen to represent the state vector X), the estimation is performed directly in the observation space (see [EQ. (6)]). Consequently, for experiments that track a shape in a video sequence, the dynamic model minimizes the distance between the predicted and the observed contours. This distance is always inferior (see [TABLE (1) below]) when the optimization has been performed in the observation space directly.

TABLE 1
Sum of Squared Errors (in pixels²) between real and predicted
contours for Time Varying (TVAR) and Time Invariant (TIAR)
Autoregressive models, for a given sequence

| | Optimization in | Optimization in |
|---|---|---|
| | feature space | observation space |
| TIAR | 1.75 × 10⁶ | 1.46 × 10⁶ |
| TVAR | 3.05 × 10⁵ | 8.12 × 10⁴ |

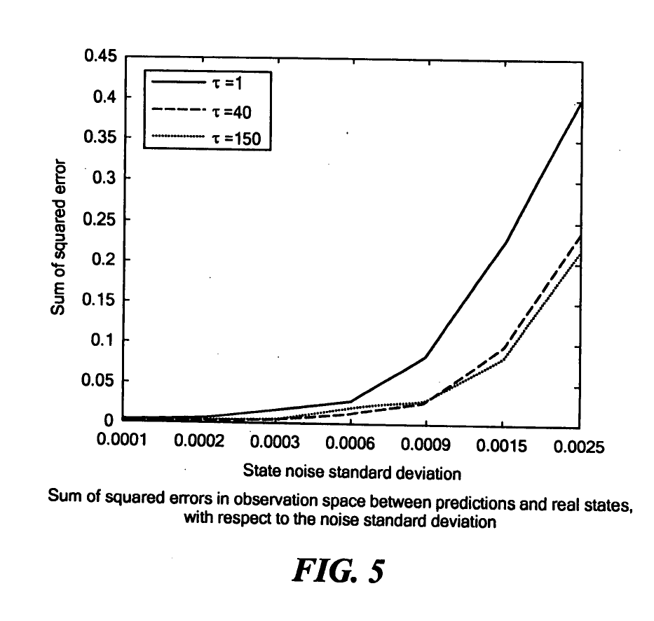

The second advantage of the method relies on the on-line update of the prediction matrix that can handle non-linear cases like a man walks before he starts running. The use of linear models could not capture such a scenario even if it is present in the training set, and therefore the on-line gradual adaptation of our model can make the transition from one state to the other in a natural fashion. Using the incremental update presented in connection with Step 122, as expected, the squared distance between predicted and observed contours were minimal for TVAR, compared to time invariant autoregressive models (see [TABLE. (1)]). Furthermore, toward validation of the exponential forgetting procedure, we have tested its importance in the process. The choice of the exponential forgetting parameter τ in [EQ. (6)] is a trade off between reactivity and robustness, as two experiments demonstrate. The first experiment is conducted with different noise levels, for different values of τ, as one can see in FIG. 5. For a given sequence, the smaller τ the more sensitive to noise. The second test to be performed is the method robustness to sudden changes, or random shocks (see M. Bask and X. de Luna. Characterizing the degree of stability of non-linear dynamic models. Studies in Nonlinear Dynamics and Econometrics, 6(1): 1002-1002, 2002). For this test, a Monte Carlo framework has been built that generates random model switches, for different τ. The results are displayed in FIG. 6. A TVAR model with a small τ reacts more quickly than with a large τ, and generates lower amplitude errors.

Last, but not least the method also updates the orthogonal basis. While such an advantage is not evident for the cases demonstrated in this paper, it becomes an important aspect when objects change pose because of the camera's point of view (people approaching the camera, etc.). Being able to continuously account for such deformations inherits to our approach the ability to initiate the process with rather generic motion human models and then customize such models in the spatial and the temporal domain.

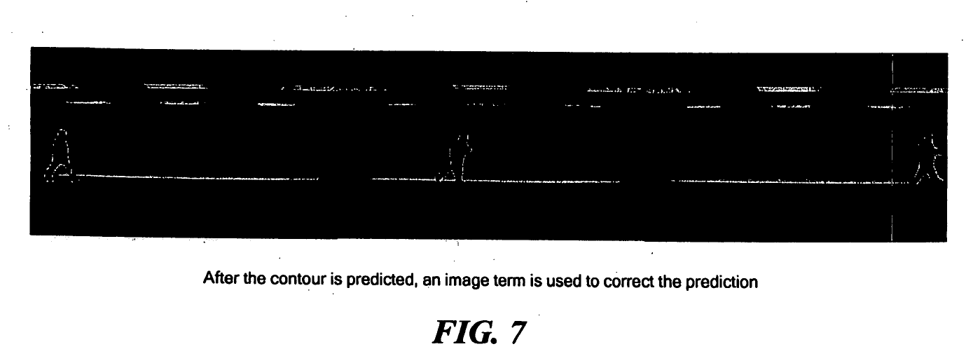

Furthermore, one can consider coupling such prediction mechanisms with image driven terms to perform knowledge-based tracking. Standards methods of image attraction/segmentation are currently under investigation with promising preliminary results. To this end, a cost function that aims to separate the object properties—within the contour—from the ones of the background while forcing the contour to be close to the prediction can cope with missing, occluded and noisy data. Some preliminary results of this effort are presented in FIG. 7.

### Discussion

Thus, with the method described above in connection with FIG. 8, an on-line method for prediction and tracking highly non-linear structures in image sequences. The method can be used as a prior in the tracking process and consists of introducing the notion of spatial and temporal coherence. To this end, in order to account for spatial coherence we have used a dimensionality reduction method on the registered set of training examples through principal components analysis (Step 122). In such an orthogonal space of limited dimensionality, the method uses of a predictive mechanism. In order to account for the multi-variate nature of the feature space (Step 120A, equation 4), we have introduced a Euclidean metric between the original observation and the prediction in this space that address in an implicit fashion the scale difference of the model parameters, (Step 120A, equation 4), Toward addressing non-linear motions and make the method independent from the training set, we have used an exponential forgetting approach to update the prediction matrix parameters when new observations are available (t equation 6, step 124). Furthermore, to cope with spatial variations and deformations of the target structure, the use of an incremental method was considered as described above in connection with Step 124 to update the vectors of the orthogonal basis. What this really means is that one does not need to perform neither the whole minimization of line 12, nor the whole process of Step 122A all over again. The solution is computed incrementally, potentially allowing real-time applications.

Tracking that integrates prediction with image features are the most prominent research direction, with enormous potentials. Action recognition is also an interesting problem that can be addressed within the method described above using multiple prediction models. In such a case, recovering the most prominent object position along with the model that best fits prior observations to new data would have to be addressed. Multiple hypotheses generation is also a direction that could be considered to address the risk of convergence to a local minimum. Segmentation of medical volumes is also a different direction. In a number of anatomical structures information is better preserved at different spatial resolutions and therefore it will be adequate to propagate information from these planes to the rest of the medical volume. Last, but not least extension of the method to 3D could be benefit facial expression recognition and animations under the assumption that proper models have been built to cope with the expression transitions.

A number of embodiments of the invention have been described. Nevertheless, it will be understood that various modifications may be made without departing from the spirit and scope of the invention. Accordingly, other embodiments are within the scope of the following claims.

What is claimed is:

1. A method for segmenting a moving object immersed in a background, comprising:
obtaining a time-varying autoregressive model of prior motion of the object to predict future motion of the object;
predicting a subsequent contour of the object from the background using the obtaining time-varying autoregressive model comprising using the obtained time-varying autoregressive model to initialize and/or constrain segmentation of the object from the background; and
segmenting the object using the predicted subsequent contour and updating the autoregressive model while tracking of the segmented object.

2. The method recited in claim 1 including modeling the object shape from prior information and updating the object shape during the object tracking.

3. The method recited in claim 1 wherein the autoregressive is model is obtained by performing contour registration of the object using a distance transformation and subsequently performing a dimensional reduction through orthogonal decomposition.

4. The method recited in claim 1 wherein the using the obtained time-varying autoregressive model to initialize and/or constrain segmentation of the object from the background includes developing a contour corrective term.

5. A method for segmenting a moving object immersed in a background, comprising:
obtaining a time-varying autoregressive model of prior motion of the object to predict future motion of the object;
predicting a subsequent contour of the object from the background using the obtaining time-varying autoregressive model comprising using the obtained time-varying autoregressive model to initialize and/or constrain segmentation of the object from the background using variational methods; and
segmenting the object using the predicted subsequent contour and updating the autoregressive model while tracking of the segmented object.

6. The method recited in claim 5 including modeling the object shape from prior information and updating the object shape during the object tracking.

7. The method recited in claim 5 wherein the autoregressive is model is obtained by performing contour registration of the object using a distance transformation and subsequently performing a dimensional reduction through orthogonal decomposition.
